(19) United States
(12) Patent Application Publication
(10) Pub. No.: US 2019/0034752 A1
(43) Pub. Date: Jan. 31, 2019

(54) Indirect View System For a Vehicle

(71) Applicant: MEKRA LANG GMBH & CO. KG, Ergersheim (DE)

(72) Inventors: Werner Jürgen LANG, Ergersheim (DE); Andreas ENZ, Burgbernheim (DE); Sebastian KELLER, Ergersheim (DE); Andreas REDLINGSHÖFER, Trautskirchen (DE)

(73) Assignee: MEKRA LANG GMBH & CO. KG

(21) Appl. No.: 16/038,799

(22) Filed: Jul. 18, 2018

(30) Foreign Application Priority Data
Jul. 25, 2017 (DE) 102017116849.4

(51) Int. Cl. G06K 9/46; G06K 9/00

(52) U.S. Cl. CPC G06K 9/46; B60R 2300/30; G06K 9/00825; G06K 9/00805

(57) ABSTRACT

An indirect view system (100) for a vehicle is provided with at least a capture unit (10) adapted for capturing image data of at least one area of view around the vehicle, at least a control unit (20) which is adapted for processing the images captured by the capture unit, and at least one reproduction (30) which is adapted for reproducing the area of view. The view system has a first setting (1) for showing the area of view and at least a second setting (2) for showing the area of view. The first setting (1) uses predetermined image parameters, and the at least second setting (2) uses image parameters which are changed in view of the first setting (1). The first setting (1) and the at least second setting (2) are usable in an at least partial low light intensity vehicle environment.

### BACKGROUND OF THE INVENTION

### 1. Field of the Invention

The present invention relates to an indirect view system for a vehicle, in particular a commercial vehicle.

### 2. Description of the Related Art

In motor vehicles, it is legally prescribed to make so-called fields of view around a vehicle visible for the driver during driving operation. Which fields of view have to be visible is based on the type of the motor vehicle, such as motor cycles, motor vehicles for transporting passengers, motor vehicles for transporting goods, etc. The visibility of the fields of view has to be provided by a device for indirect view and the fields of view have to be visible for a driver, who sits on the driver's seat, all the time by using the device for indirect view. Depending on the type of the vehicle and in particular thereon, which areas around the vehicle can be directly seen by the driver, different legal prescriptions require that certain fields of view are permanently and reliably visible by using the device for indirect view. In Europe, the fields of view which have to be permanent reliably visible for a driver are defined in the UN/ECE-Regulation No. 46, which is further described below. Further, relevant norms and regulations, respectively, include, for instance, the ISO 5721, ISO 5006, ISO 16505, ISO 14401 and the EU 167/2013. Besides the legally required fields of view, often further areas around the vehicle, so-called areas of view, are made visible by the device for indirect view. Areas of view may contain legally prescribed fields of view.

Commonly, the observation of the fields of view is possible with one or more mirrors. However, mirrors have some drawbacks. For instance, mirrors show merely objects to the driver which are on the same side of the mirrors as the driver. Any object behind a mirror cannot be shown by this mirror. In addition, mirrors which are merely made from flat glass show the driver a small area, unless the mirrors are very close to the driver. If they are formed convexly, this produces an image distortion. Big vehicles typically have six or more mirrors which are mounted around the outsight of the vehicle and the most of which are distorted and convex, which makes it difficult for the driver to pay attention to all relevant mirrors at the same time. Nevertheless, there are typically still blind spots around these vehicles, despite all of the mirrors.

In recent times, it is becoming increasingly common to consider using camera systems as devices for indirect view either in addition to or as a replacement for the mirrors as devices for indirect view. In such camera systems, an image sensor device continuously captures (detects and stores) an image. The (video-)data captured by the image capture unit are transmitted, e.g., by using a supply unit and optionally after further processing, to a display device located in the driver's cabin. The display device depicts a view into the corresponding legally-prescribed field of view or a plurality of fields of view and optionally supplemental information, such as e.g., possible collision risks, distances to other objects, etc., for the area around the vehicle in a manner that is permanently viewable at all times for the driver. At the same time, the view system offers a superior night vision, more flexible placement options and larger fields of view with the opportunity for less distortion. For example, DE 10 2013 220 839 A1 discloses a camera system for a vehicle.

Permanently viewable means in this context that the view into the field of view is depicted in a timely uninterrupted manner, i.e., not interrupted by alternatingly showing and hiding the fields of view or parts thereof or by overlaying other representations such that the field of view cannot be seen completely. Accordingly, the respective field of view or the fields of view are continuously and in real time shown on the display device. This holds at least for fields of view which have to be permanently visible for all vehicle conditions, in which the ignition is switched on, preferably e.g., coupled to a sensor, which receives a corresponding signal, e.g., a door opening signal or an ignition switch signal.

Modern mirrors create a nearly perfect sharp image for a driver. The level of detail available to the driver is dependent on the distance to the object and the eyesight of the driver. In camera systems, the level of detail is influenced by many different parameters: the resolution of the camera sensor, the field of view of the camera, but also the resolution of the monitor, which part of the camera field of view is shown on the monitor and how big this part is, how far the monitor is spaced from the driver's position/place and the eyesight of the driver. In some combinations of those parameters, drivers may be able to zoom in and see far-off objects clearly that they would be unable to see or to see correspondingly in detail in a mirror.

With indirect view systems, a capture unit (e.g., a camera) captures images of the surroundings (environment) of the vehicle. The images captured by the camera are transmitted as image data to a control unit (e.g., a ECU), if so (i.e., if processing is necessary), where the image data are processed by means of prescribed (image-)parameters. Afterwards, the processed image data are shown on at least one reproduction unit (e.g., a monitor). Dependent on the camera (and the image sensor, respectively) and the parameters which are used for processing the image data, the images of the vehicle surroundings which are shown on the monitor correspond more or less to the actual surroundings of the vehicle. Specifically, the reproduction of images on the monitor is typically adapted based on parameters such that the driver of the vehicle obtains a quick and exact overview over the surroundings of the vehicle in a comfortable manner. Namely, the surroundings are regularly not exactly shown as they are taken by the sensor, but the image is adapted and improved (e.g., to legal requirements or driver requirements, as long as the legal requirements are not disregarded/violated) by adapting image parameters, such as the contrast, the color saturation, the color, temperature, etc.

Generally, during capturing of the vehicle surroundings in daytime or in bright environment, however, a lesser adaptation of the image data is required than at night time or in a dark environment, because the camera sensor receives a larger light quantity at daytime than at night time. In other words, the image data captured by the camera at daytime or in bright surroundings are such detailed alone due to the light quantity impacting on the sensor that the image data hardly have to be processed by the control unit/calculation unit and the reproduction of the image data on the monitor correspond substantially to the images of the vehicle surroundings which are captured by the camera. The light quantity present at daytime is generally called day light. Day light is present if an area (e.g., a vehicle environment) is well illuminated, i.e., has a light intensity as at daytime (commonly, between around 1.000 and 100.000 lx [lux]). In this respect, the term “day-light” is independent on whether the vehicle surroundings are illuminated by the sun or an artificial light source, as long as the surroundings generally have the above-mentioned light intensity values and, thus, can be called “bright”.

At night or in dark surroundings, to the contrary, a stronger adaptation of the image data is required than at daytime, because the camera sensor receives a smaller light quantity at night than in daytime. In other words, the image data captured by the camera at night are insufficient due to the small light quantity impacting on the sensor such that the image data have to be greatly processed by the control unit, in order to show the driver meaningful, comprehensible images on the monitor, on which objects in the vehicle surroundings may be identified. At night or in dark surroundings, there is generally darkness. Darkness is present, if an area (e.g., vehicle environment) is weakly/slightly illuminated or is not illuminated at all (low light intensity surroundings), i.e., has a light intensity as at night (generally, between around 0 and 1.000 lx [lux]). In this respect, it is independent on whether the vehicle surroundings are badly illuminated due to missing sun light or artificially due to buildings (e.g., basement garages), as long as the surroundings generally have the above-mentioned light intensity values and, thus, can be called “dark”. As the vehicle surroundings are typically difficult to view/identify at night, they are illustrated to the driver in the driver's cabin on the monitor commonly brighter than the light intensity, which is actually available in the surroundings. For this, for example, an additional lighting disposed at the vehicle can be used in order to increase the light intensity of the vehicle surroundings. Alternatively, sensors for detecting objects, such as thermal image sensors or radar sensors, may be used in order to detect potential obstacles and to let them be shown on the monitor.

However, in camera-monitor-systems as indirect view systems for vehicles, in particular with an admittance according to the requirements of the ECE-R46 for mirror replacement systems, the surroundings around a vehicle can be insufficiently illustrated for a driver at darkness (i.e., at low light intensity surroundings). The requirements of the ECE-R46, such as the perceptibility or the discernability of point light sources, and a limited dynamic range (contrast range) of the capture unit for capturing areas of view around the vehicle prevent that details in dark portions of the areas of view are visible and cognizably shown on the monitor for a driver. On the other side, a reproduction of details in dark portions of the areas of view would lead to a loss of details in bright portions of the areas of view. For instance, the discernability of point light sources would be reduced thereby or would not exist any longer. Thus, in existing view systems, the driver cannot identify bodies, such as pedestrians, un-illuminated vehicles or other obstacles, on the monitor at partial or complete low light intensity surroundings, which may lead to dangerous situations and, if so, to accidents.

### SUMMARY OF THE INVENTION

Accordingly, it is an object of the present invention to provide an indirect view system for a vehicle, in particular a commercial vehicle, which provides the driver with all necessary information for assessing the surroundings in at least partial low light intensity vehicle surroundings.

The above-mentioned object is solved with an indirect view system for a vehicle with the features of claim 1. Preferred embodiments are given in the dependent claims.

The invention is based on the idea to optimize processing of image data in at least partial low light intensity vehicle surroundings for reproduction on a reproduction unit, such as a monitor, such that the driver can quickly and in detail view/identify all safety relevant information. In this respect, the view system has two settings for reproducing at least one area of view around the vehicle, which may be used in at least partial low light intensity surroundings. Both the first setting and at least the second setting are settings for low light intensity surroundings. Apart from that, the view system has one or more settings for daylight surroundings. Further, the indirect view systems may have further settings (a third and further settings) for low light intensity surroundings.

The first setting uses predetermined image parameters for processing the image data captured by a capture unit. The predetermined image parameters comprise, for instance, a predetermined (i.e., determined, defined in advance) adaptation of the contrast, the color temperature, the saturation etc. of image data, which are captured by the capture unit. The predetermined image parameters are—dependent on normal driving situations, such as highway tours or overland tours, and on the remaining light quantity available to the capture unit—always equal. The predetermined image parameters may be determined empirically for different normal driving situations and conditions (e.g., the driving speed) and for different remaining light quantities and may be stored in a data base, a table or the like and may be chosen respectively by a control unit (e.g., a ECU, a processor, etc.) dependent on which light conditions are present in the vehicle surroundings.

The second setting uses image parameters, which are different in view of the image parameters of the first setting for processing the image data captured by the capture unit. The changed and different, respectively, image parameters comprise a changing of the contrast, the color temperature, the saturation, etc. of the image data, which are captured by the capture unit. The changed image parameters are—dependent on specific driving situations, such as driving maneuvers (e.g., shunting, turning, etc.), conditions in the vehicle surroundings, conditions in the driver's cabin, the driver's behavior, etc.—always changeable and adjustable, respectively.

For determining which predetermined image parameters or which changed image parameters are to be used in the first and the second settings, the driving situation of the vehicle as well as the remaining light quantity in the vehicle surroundings are steadily monitored.

The image parameters comprise the resolution, the contrast, the saturation, the color temperature (i.e., the white balance), the shades of color, the exposure, etc. of image data. Thus, an adaptation of the image parameters is performed by varying the resolution of the image sensor of the capture unit (smaller resolution or a resolution equal to the native resolution of the image sensor), the graduation curve of the shown image (i.e., that the contrast of the image is changed), the color saturation, the color temperature and the shades of color of the image, the exposure of the image sensor (i.e., that the focal aperture and/or the exposure time are adapted), etc. Furthermore, an adaptation of the image parameters may be performed by so-called pixel mapping. Pixel mapping means a clustering of a plurality of sensor pixels, in order to enlarge individual small and, thus, low light intensity pixels and, thus, to cluster them to highlight intensity pixels and, thereby, to increase the exposure/illumination of the pixels. Pixel mapping is performed by the control unit. Alternatively or additionally to the above-mentioned adaptations of the image parameters, an adaptation of image parameters may also be performed by attaching and using an additional light source or a thermal imaging camera (monochrome or colored) at the vehicle. Thereby, the dark portion of the vehicle surroundings may be illuminated, such that the light intensity of the vehicle surroundings is increased and a detection of obstacles may be performed by means of the thermal image, respectively.

At least partial low light intensity surroundings around a vehicle means that the vehicle is not necessarily completely, but only partially located in the dark. For instance, this is the case, if part of the vehicle is located in a dark hall, whereas the other part of the vehicle is located outside the hall in daylight. Low light intensity surroundings mean surroundings which are poorly illuminated or which are not illuminated at all, such as in a basement garage or at night. In low light intensity (dark) surroundings, the light quantity ranges from around 0 to 1.000 lx, whereas in high light intensity (bright) surroundings, the light quantity ranges from around 1.000 to 100.000 lx. Surroundings of the vehicle means close areas, areas of view and legally prescribed fields of view around the vehicle, wherein areas of view may contain legally prescribed fields of view.

During operation of the indirect view system according to the invention, the first setting is commonly used in case of low light intensity vehicle surroundings. For instance, the first setting is used for tours on highways or overland, wherein it is necessary to identify other moving vehicles and details in dark areas of the image disturb the driver and, thus, shall not be shown. If it is detected based on the driving situation that the first setting does not suffice, so that the driver can quickly and reliably view into the surroundings around the vehicle and, thus, can assess the surroundings around the vehicle, the second setting is used. For instance, the second setting is used in case of shunting operations at unlighted locations, turning operations at unlighted crossroads or stepping out of the driver from the driver's cabin on an unlighted parking place.

In the first setting, thus, the image parameters are optimally determined for the normal driving operation, whereas in the second setting, the image parameters are determined for situations, which differ from a normal driving operation and, thus, are called specific driving operation. At least in the first setting, all legal requirements for each of the areas of view have to be fulfilled at any time. If the view system is adapted such that the second setting is used only in driving situations, in which no legal requirements have to be fulfilled for each of the areas of view, a second setting has not necessarily to fulfil the legal requirements. In surroundings with very different light conditions (glittering sun light in front of a building and darkness within the building) or in overall very dark surroundings around the vehicle, thus, the second setting allows the driver to identify dark objects and, thereby, possible accidents. Thereby, no additional sensors are necessary and it is possible to save costs.

Preferably, in the second setting, at least an amplification of the luminous sensitivity of the capture unit (e.g., the image sensor) is performed for brightening the image captured by the image sensor. The mode of operation of image sensors corresponds substantially to that one of photo diodes, wherein light is converted into an electrical current. The electrical current and the voltage respectively, is an analog signal. In an analog-digital-converter (ADU, A-D-converter), the current and the voltage, respectively, are converted into a digital signal for usage in a digital signal processor. Thus, the amplification is performed either preferably in the analog part of the image sensor, or alternatively, in the digital part of the image sensor.

Further, preferably, the second setting attenuates (by overriding, clipping) image data which are located in a highlight intensity (bright) part of an area of view by increasing the exposure time and/or by additional amplification and/or by using at least one further exposure time and/or by adaptation of the dynamic compression whereby the image data which are located in the low light intensity part of an area of view are highlighted and, thus, better visible.

Alternatively, the second setting highlights image data which are located in a low light intensity (dark) part of an area of view by increasing the exposure time and/or by additional amplification and/or by using at least a further exposure time and/or by adaptation of the dynamic compression, whereby the image data, which are located in the low light intensity part of an area of view are also highlighted and, thus, better visible.

According to a preferred embodiment, the usage of the second setting may be based on driver's inputs. In this respect, the driver may select the second setting either due to his behavior or due to manual inputs. Driver's behavior includes every movement or voice command of the driver. Thus, the driver's inputs may preferably result from monitoring the driver. For example, a driver's behavior may be determined via tracking the eye movement of the driver (eye tracking). Additionally or alternatively, the driver may preferably manually select the two settings, for instance, by operating a turning knob, a switch, a lever, a feeler, a joystick, by a touchpad input, etc.

Alternatively or additionally to the usage of the second setting based on driver's inputs, the second setting may also be based on vehicle data and/or image data, which are preferably automatically detected. Vehicle data comprise light intensity information of the sensors mounted in or on the vehicle, information of positioning systems (GPS (Global Positioning System), Galileo, Compass, Glonass or other positioning systems, which are for instance supported by satellites), the time, a speed signal, a reverse gear signal, etc.

According to a preferred embodiment, the capture unit for capturing an area of view around the vehicle uses at least two different exposure times, in order to capture low light intensity areas in vehicle surroundings with different light intensities. Subsequently, the images with the different exposure times may be joined. Thus, a single image with a high contrast may be generated. Such methods are, for instance, possible, if a capture unit is a HDR-capable camera. HDR-capable cameras may generate images with high contrasts, so-called high dynamic range images, which result from superimposing two images with different exposure times.

Preferably, the capture unit is a HDR-capable camera and the second setting is adapted to highlight image data in low light intensity areas in the vehicle surroundings by means of a dynamic compression (tone-mapping). When using a HDR-capable camera, a dynamic compression is necessary for performing a dynamic adaptation to monitors, which cannot show HDR-images.

With the indirect view system according to a preferred embodiment, the requirements of legal prescriptions (such as the ECE-R46, in particular, the reproduction of the fields of view prescribed therein, in particular of group I and/or II and/or III and/or IV and/or V and/or VI, or the reproduction of light sources/-points at darkness) are fulfilled. For example, the first setting and the at least second setting show bright point light sources in low light intensity vehicle surroundings distinguishable from each other on the reproduction unit. As an example, a situation may be described, wherein the flood lights of a vehicle which is located in a distance of around 200 m are illustrated as two light sources on the reproduction unit. If this requirement is not fulfilled, this is preferably shown advised to the driver, for instance, in form of a superimposition, a cross-fading, an alert etc.

According to a preferred embodiment, the control unit is adapted to carry out the first setting and/or the second setting. The control unit may be provided as a single component in the indirect view system or may be integrated in the capture unit or the reproduction unit.

According to a preferred embodiment, the view system is a mirror replacement system, which replaces one or more common mirrors (in particular, for monitoring/viewing legally prescribed fields of view). Such a mirror replacement system may be a camera monitor system. In such camera monitor systems, an image sensor device continuously captures (determines and, if so, stores) an image. The (video-)data, which are captured by the image capture unit, for instance, are transferred to a reproduction unit which is located in the driver's cabin by using a supply unit and, optionally, after further processing. The reproduction unit reproduces a view of the correspondingly legally prescribed fields of view and a plurality of fields of view and, optionally, additional information, such as possible risks of collision, distances to other objects, etc. for the area around the vehicle in a manner, such that the fields of view are permanently visible for the driver at any time. At the same time, the view system provides an improved night view, flexible arrangement possibilities and larger fields of view with the possibility of lower distortion.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the following, the invention will be exemplarily described with reference to the enclosed figures, in which:

FIG. 1 shows a schematic structure of the indirect view system according to the invention,

FIG. 2 shows a histogram of an image in accordance with a first setting,

FIG. 3 shows a histogram of the image of FIG. 2 in accordance with the second setting,

FIG. 4 shows a symbolic illustration of a vehicle environment,

FIGS. 5A and 5B show an image of a vehicle environment with the first setting according to FIG. 2, and

FIGS. 6A and 6B show an image of a vehicle environment with the second setting according to FIG. 3.

### DETAILED DESCRIPTION OF THE PRESENTLY PREFERRED EMBODIMENTS

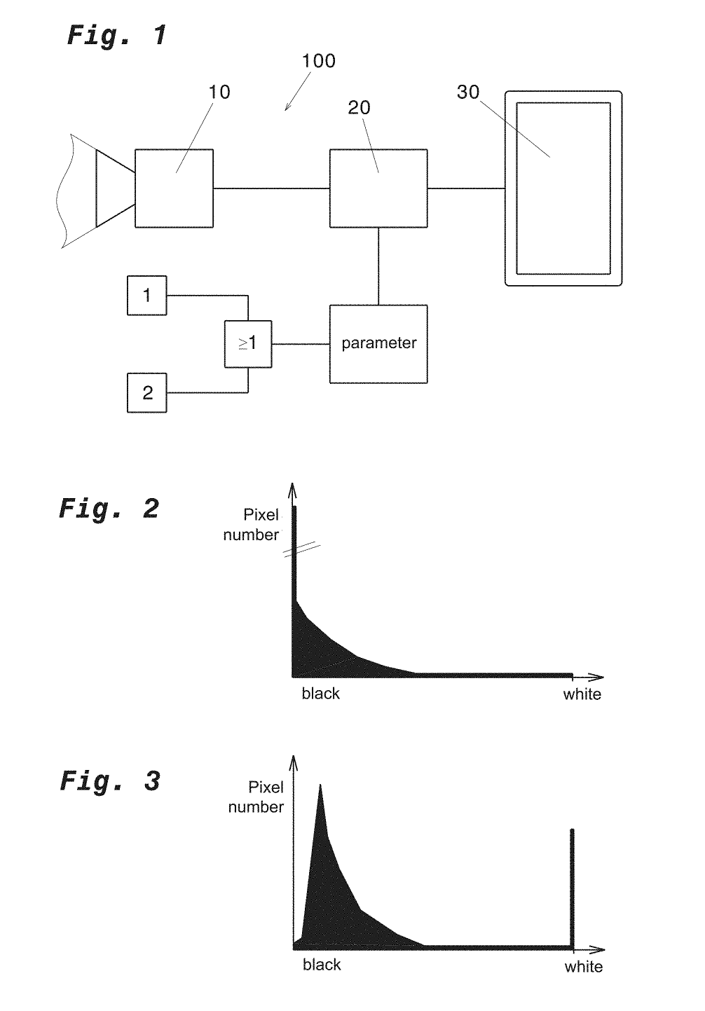

FIG. 1 shows a schematic structure of an indirect view system 100 according to the present invention. The indirect view system 100 has a capture unit 10, a control unit 20 and a reproduction unit 30.

The capture unit 10 is adapted to capture images of surroundings around a vehicle (not shown), in particular a commercial vehicle, in the form of image data. For this, the capture unit 10 is attached to the vehicle in a suitable manner. The capture unit 10 may be a camera, in particular a camera with a sensor according to a CMOS- or CCD-technology or any other image sensor, which is suitable for capturing moving pictures. A plurality of capture units 10 may be provided. The capture 10 communicates with the control unit 20, for example, via connecting cables or radio communication.

The control unit 20 is adapted for processing the image data captured by the capture unit 10. In this respect, the control unit 20 uses predetermined/changed image parameters, such as the resolution, the contrast, the color saturation, temperature and shades, the exposure, etc. The image parameters may be changed by means of the control unit 20 or additionally or alternatively may be changed by an adaptation of the vehicle environment, such as attaching and using of an additional light source or a thermal image sensor at the vehicle. The control unit 20 has at least two settings 1 and 2. Both setting 1, 2 are used in low light intensity surroundings and serve for selecting (first setting 1) or adapting (second setting 2) of parameters such that the necessary and/or prescribed information are shown to the driver on the reproduction unit 30. In this respect, legal requirements (such as legally prescribed fields of view or the illustration of point light sources) may be fulfilled, wherein, in case of illustrating point light sources, it is sufficient to indicate an insufficient detailed illustration, which does not allow a differentiation of point light sources by means of a corresponding hint on the reproduction unit 30. The sign “≥” illustrated in FIG. 1, presently, refers to a logic operation of both setting 1 and setting 2 such that (in a low light intensity environment) always one of the two settings 1, 2, however, never a combination of the two settings 1, 2 is to be used. The control unit 20 communicates with the reproduction unit 30, for instance, via connecting cables or radio communication.

The reproduction unit 30 is adapted for reproducing images which have been captured by the capture unit 10 and have been processed by the control unit 20. The reproduction unit 30 may be a monitor, such as a LCD, TFT or LED monitor. A plurality of reproduction units 30 may be provided.

Setting 1 is primarily selected in normal driving situations, such as highway tours or overland tours. Setting 1 uses predetermined parameters, which may be stored in data bases, tables, etc. Setting 2 is primarily selected in special driving situations (which differ from the normal driving situation), such as driving manoeuvers, such as shunting, turning, reverse driving, etc., or special conditions in the surroundings of the vehicle, the driver's cabin, the driver's behavior. Setting 2 uses changed (in view of the setting 1 changed and adapted, respectively) image parameters, which are detected by monitoring the driving situation. The selection of setting 1 and 2 occurs either automatically by detecting driving signals (speed, turning angle of the steering wheel, turn signal, time, GPS, sensors mounted on the vehicle, etc.) and/or by detecting driver's inputs (manual inputs, driver's movements, voice commands, etc.). It is also conceivable that the settings 1 and 2 are applied in special and normal driving situations (i.e., are interchanged, inverted to each other), respectively, as long as the legal prescriptions (such as legally prescribed fields of view or the illustration of point light sources) are complied with.

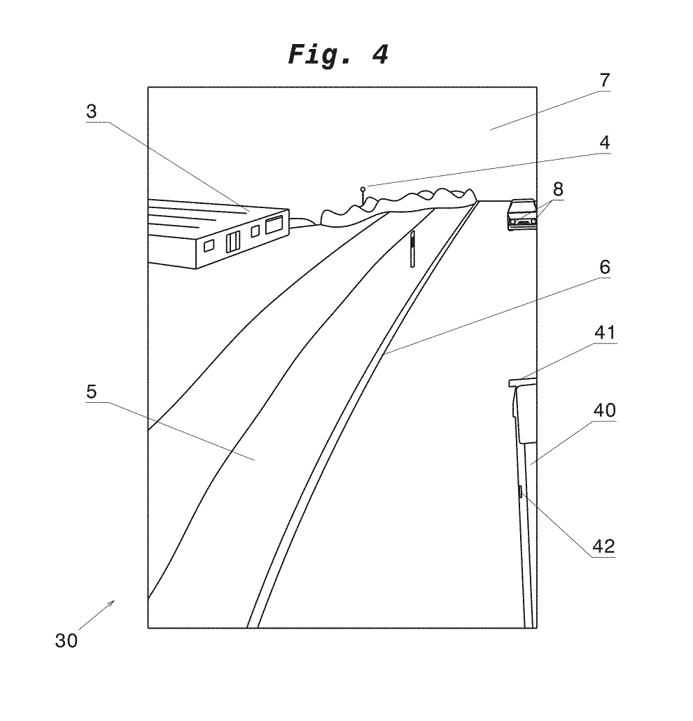

FIG. 2 shows a histogram of an image shown on the reproduction unit 30, which is adapted to predetermined parameters by means of setting 1. A histogram graphically illustrates the pixel distribution of an image with respect to the different light intensity levels. The histogram shows details in dark picture/image areas (left part of the histogram), in middle picture/image areas (center) and in bright picture/image areas (right part). Presently, the light intensity of the pixels is assigned from black (leftmost) to white (rightmost) on the X-axis (axis which runs from left to right in the plane of the sheet). On the Y-axis (axis which runs from down to up in the plane of the sheet), the number of pixels is allocated from zero (downmost) to n (upmost, n=a natural number). The histogram shown in FIG. 2 represents the frequency of pixels in the corresponding light intensity. As it can be taken from the histogram shown in FIG. 2, a major part of the image pixels shown from the reproduction unit is located at the left end of the X-axis (at the end at which the pixels are dark and “black”, respectively) and, thus, are mainly dark. Such an illustration of pixel corresponds to a reproduction of a dark environment with setting 1 as it is used during a highway tour or an overland tour, and an illustration of bodies in the environment/surroundings is not necessary, except for point light sources of a vehicle moving in the surroundings.

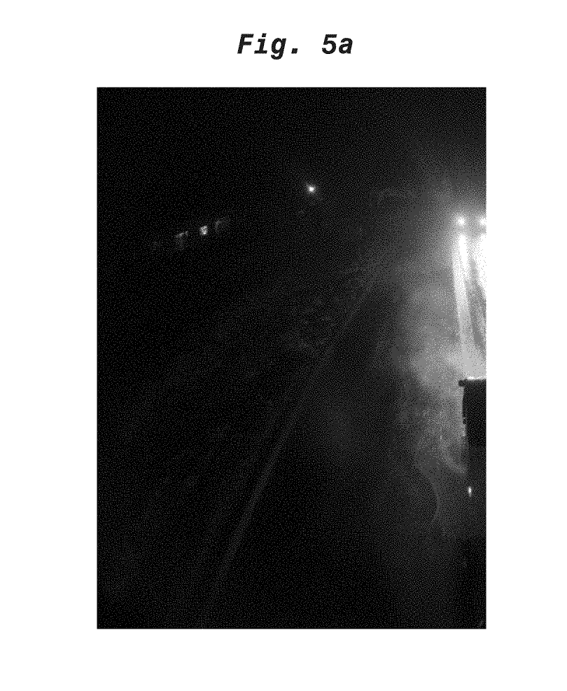

FIG. 3 also shows a histogram, which is structured as the one in FIG. 2, wherein the image from FIG. 2 shown on the reproduction unit 30 is slightly brightened, i.e., is slightly displaced to the right in the direction “white”. Thus, the pixels are no longer at the left end of the X-axis, as in FIG. 2, but are slightly displaced to the right and, consequently, are illustrated brighter on the reproduction unit. Such an illustration of pixels corresponds to the reproduction of a dark environment with the setting 2, as it is, for instance, used at special driving manoeuvers (shunting, turning, reverse driving, etc.), which require a brighter illustration of the dark environment than during a highway tour or an overland tour and a figurative highlighting of bodies in the environment, without violating legal prescriptions.

An adaptation of the image parameters, as they are shown in FIG. 3, can occur by changing the resolution, the contrast, the saturation, the color temperature (the white balancing), the shades of color, the exposure, etc., of image data. Alternatively or additionally to the adaptation of image parameters by the control unit, an adaptation of image parameters may also occur by attaching an additional light source or a thermal image camera (monochrome or colored) at the vehicle. Thereby, the dark part of the vehicle surroundings may be illuminated such that the light intensity of the vehicle surroundings is increased and such that a detection of obstacles by means of a thermal image is possible, respectively.

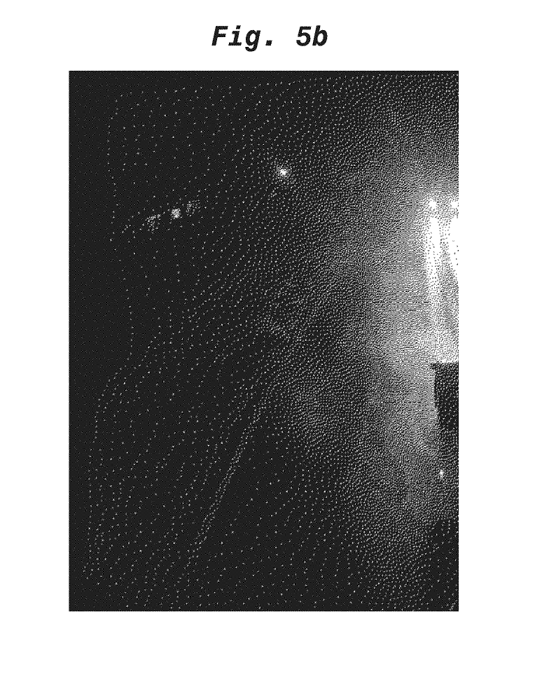

In FIG. 4, a vehicle environment, as it is visible for a driver on a reproduction unit 30 is symbolically illustrated. On the left side of the image, a building 3 with (illuminated) windows is illustrated. In the center, a lantern 4, a roadside ditch 5 and a road marking 6 are illustrated. On the right side of the image, a horizon 7, a passenger car 8, part of a truck 40 (tractor without trailer), part of a truck rear light 41 and a side marking light of the truck 42 are illustrated.

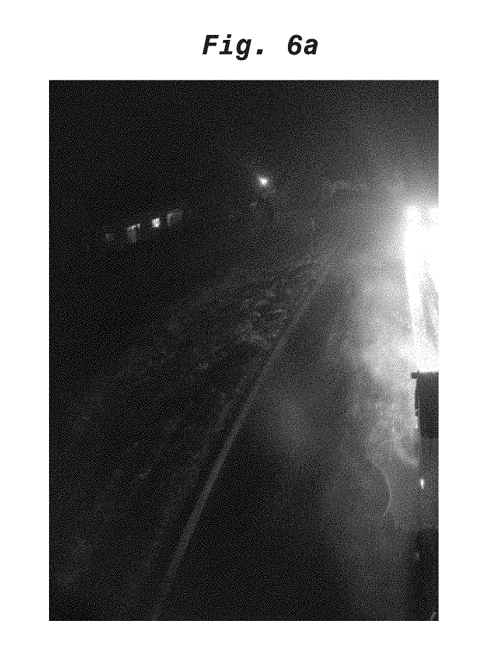

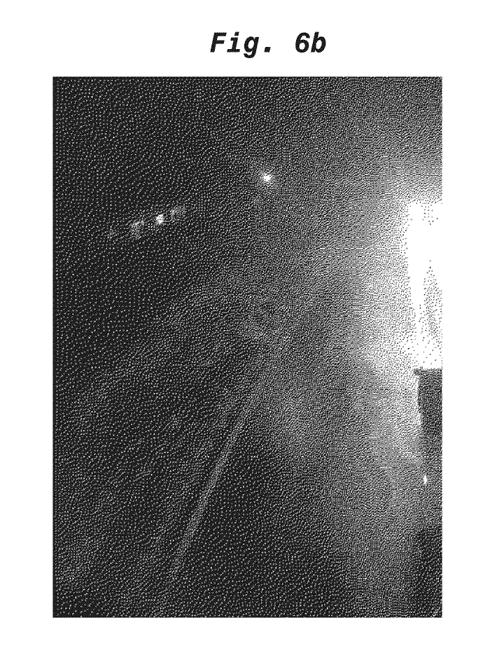

During driving (e.g., on a highway or overland) at a low light intensity environment or even darkness, the view system 100 uses setting 1 (as it is shown in FIG. 5A), whereby the driver sees substantially only the flood lights of the passenger car 8 as point light sources on the reproduction unit 30. For instance, during a shunting operation at low light intensity environment or even darkness, the view system 100 uses (either automatically or by means of one or more corresponding driver inputs) setting 2 (as it is shown in FIG. 6A), whereby a change of the image parameters for reproduction of the image data on the reproduction unit 30 occurs such that the driver is now capable to view the environment in a better way (such as the building 3, the road marking 6, etc.). Thereby, the flood lights of the passenger car 8 are usually no longer cognizable as point light sources, what is admissible according to the ECE-R46, if this is indicated to the driver, for instance, by a corresponding symbol (icon) on the reproduction unit, such as a monitor. Alternatively, it is conceivable in order to avoid that the flood lights of the passenger car 8 are not shown as very bright points, in the worst case as not separately visible point light sources, the changing of the image parameters occurs only in the areas of the environment with low light intensity, namely the vehicle surroundings which do not comprise the passenger car 8. Thus, the driver can well view the environment, e.g., during shunting, and can quickly get an impression of the environment, without being dazzled by the flood lights of the passenger car 8 or without that he does not identify the flood lights as such.

FIGS. 5A and 5B show an image of the vehicle environment illustrated in FIG. 4 with setting 1, as it is approximately also shown on the reproduction unit 30 in the driver's cabin, wherein FIG. 5A substantially corresponds to the illustration as it is shown in the driver's cabin and FIG. 5B is a rendered view. As it is shown in FIG. 5A, the flood lights of the passenger car 8 are well visible and distinguishable, respectively, as separate point light sources. Details in dark areas of the vehicle environment are not visible. The image shown in FIG. 5A corresponds to the histogram shown in FIG. 2, wherein the image contents are strongly displaced in the direction of the black area and the pixels are clustered along a certain light intensity threshold in the image to a minimal value (see peak at the left, i.e., the black end of the histogram).

FIGS. 6A and 6B show an image of the vehicle environment illustrated in FIG. 4 with setting 2, as it is approximately also shown on the reproduction unit 30 in a driver's cabin, wherein FIG. 6A substantially corresponds to the illustration as it is shown in the driver's cabin, and FIG. 6B is a rendered view. As it is shown in FIG. 6A, the flood lights of the passenger car 8 are merely poorly visible and distinguishable, respectively, as separate point light sources. Whereas, details in dark areas around the vehicle environment are visible in a better way compared to FIG. 6A. The image shown in FIG. 6A corresponds to the histogram shown in FIG. 3, wherein the image contents are illustrated in a brightened manner in the black portion and the pixels are clustered over a certain light intensity threshold in the image to the maximal value (see peak at the right, i.e., the white end of the histogram).

It is explicitly stated that all features disclosed in the description and or the claims are intended to be disclosed separately and independently from each other for the purpose of original disclosure as well as for the purpose of restricting the claimed invention independent on the composition of the features in the embodiments and/or the claims. It is explicitly stated that all value ranges or indications of groups of entities disclose every possible intermediate value or intermediate entity for the purpose of original disclosure as well as for the purpose of restricting the claimed invention, in particular as limits of value ranges.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. An indirect view system for a vehicle, comprising:
at least one capture unit which is adapted for capturing image data of at least an area of view around the vehicle;
at least one control unit which is adapted for processing the image data which are captured by the capture unit; and
at least one reproduction unit which is adapted for reproducing the area of view;
wherein the indirect view system has a first setting for showing the area of view and at least a second setting for showing the area of view; wherein
the first setting uses predetermined image parameters;
the at least second setting uses image parameters which are changed in view of the first setting; and
the first setting and at least the second setting are usable in an at least partial low light intensity vehicle environment depending on the driving situation.

2. The indirect view system according to claim 1, wherein in the second setting at least an amplification of the luminous sensitivity of the capture unit occurs.

3. The indirect view system according to claim 2, wherein the amplification occurs in the analog part of the image sensor of the capture unit.

4. The indirect view system according to claim 2, wherein the amplification occurs in the digital part of the image sensor of the capture unit.

5. The indirect view system according to claim 1, wherein the second setting attenuates image data which are located in a highlight intensity part of an area of view by increasing the exposure time and/or by additional amplification and/or by using at least one further exposure time and/or by an adaptation of the dynamic compression.

6. The indirect view system according to claim 1, wherein the second setting highlights image data which are located in a low light intensity part of an area of view by increasing the exposure time and/or by additional amplification and/or by using at least one further exposure time and/or by adapting the dynamic compression.

7. The indirect view system according to claim 1, wherein using of the second setting is based on driver's inputs.

8. The indirect view system according to claim 7, wherein the driver's inputs occur manually.

9. The indirect view system according to claim 7, wherein the driver's inputs occur by means of the driver's behavior.

10. The indirect view system according to claim 1, wherein using the second setting is based on vehicle data and/or image data.

11. The indirect view system according to claim 1, wherein the capture unit is a HDR-compatible camera, which uses at least two different exposure times for capturing an area of view around the vehicle.

12. The indirect view system according to claim 1, wherein the capture unit is a HDR-compatible camera and the second setting is adapted to highlight image data in low light intensity areas of the vehicle environment by means of a dynamic compression.

13. The indirect view system according to claim 1, wherein the requirements of legal prescriptions are fulfilled.

14. The indirect view system according to claim 1, wherein the first setting and the second setting show at least two bright point light sources in a low light intensity vehicle environment distinguishable from each other on the reproduction unit.

15. The indirect view system according to claim 1, wherein the control unit is adapted to carry out the first setting and/or the second setting.

16. The indirect view system according to claim 1, wherein the view system is a mirror replacement system.
